(19) United States
(12) Patent Application Publication
(10) Pub. No.: US 2008/0018152 A1
(43) Pub. Date: Jan. 24, 2008

(54) Collapsible Portable Child Safety Seat

(76) Inventor: Ilan Vadai, Pardes Hanna (IL)

Correspondence Address: PEARL COHEN ZEDEK LATZER, LLP, 1500 BROADWAY 12TH FLOOR, NEW YORK, NY, 10036, US

(21) Appl. No.: 10/588,654

(22) PCT Filed: Feb. 22, 2005
(86) PCT No.: PCT/IL05/00215

§ 371 Date: Jul. 5, 2007

Related U.S. Application Data
(60) Provisional application No. 60/546,440, filed on Feb. 23, 2004.

(51) Int. Cl. B60N 2/28

(52) U.S. Cl. 297/255; 297/464

(57) ABSTRACT

A collapsible child safely seat device for use in a vehicle, the device comprising a seating portion pivotally connected to a back support, the back support comprising a backrest portion and a headrest portion, wherein the seating portion and back support may be folded together, wherein the sealing portion and the back support may be laterally narrowed, and wherein the headrest portion can be retracted or folded to at least partially overlap with the backrest portion, whereby the collapsible child safety seat device can be transformed between a deployed position where all the parts are deployed and a compact position where all the parts are collapsed.

### FIELD OF THE INVENTION

The present invention relates to portable child restraint systems for vehicles. More particularly it relates to collapsible child safety seats and boosters.

### BACKGROUND OF THE INVENTION

A child safety seat is a child restraint system that is fixed to a vehicle's passenger seat with the vehicle's adult safety belts or with a rigid connection. The child safety seat has its own restraint system, typically belts or a structural element, for the purpose of restraining, seating, or positioning a child.

A child safety booster seat (“booster”) is another type of child restraint system, similar to the child safety seat. However the booster's purpose is to position the child on the vehicle seat to improve the fit of the vehicle's adult safety belts on the child. The booster therefore lacks its own restraint means.

The current invention addresses reducing the size factor of a child safety seat or booster when not in use. The invention can generally be embodied equally in a child safety seat or in a booster as the principles of the invention are not compromised by the differences between a child safety seat and a booster. For the purposes of clarity in this disclosure, the term “child safety seat” when applied to the current invention should be taken to refer equally to a “booster” unless specified otherwise (for example, when referring to prior art that reads on only one of the two types of child restraint system).

Conventional child safety seats are molded, single structure apparatuses and thus are bulky, heavy, and inconvenient to carry around while traveling or in transit. They are also space inefficient when not in use, when stored, when in shipment and at the retail level.

Therefore, vehicle users would benefit from a child safety seat that easily collapses or folds to a compact size, thereby facilitating convenient carrying and efficient storing the seat. Manufacturers and sales channels would benefit from such a seat in reduced shipping costs and storing and display space requirements.

There have been several prior attempts to address the space inefficiency of conventional child safety seats. One type of solution is provided in two variations by Meeker, et al.

In US patent application 20040061366, entitled “FOLDABLE BOOSTER CAR SEAT”, they disclose:

“A collapsible car seat which comprises: (a) a seat member having a top and a bottom; (b) a back member having a front and a back; (c) a means for selectively positioning said seat member from an essentially L-shaped first position to a second essentially collapsed position wherein said top of said seat member is adjacent to said front of said back member.”

And in US patent application 20040124677, entitled “ADJUSTABLE AND FOLDABLE BOOSTER CAR SEAT”, they disclose:

A collapsible car seat which comprises: (a) a seat member; (b) a back member pivotally connected to said seat member, said back member further comprising: (i) a fixed component; and (ii) a movable component; (c) means for selectively positioning said seat member from an essentially L-shaped first position to a second essentially collapsed position wherein a top of said seat member is adjacent to a front of said back member; (d) means for selectively positioning said movable component relative to said fixed component.

In both applications the booster seat member folds up to the back member, thereby moving from an L-shaped open position into a book-like folded position. 20040124677 further discloses extending the height of the back through repositioning a head rest element to a higher position, thus accommodating a taller child.

While these solutions provide a reduction in the overall seat volume by folding the seat up and adjacent to the back, they do not provide a reduction in the seat's width. Furthermore they do not include a reduction in the length of the back.

Another solution is described in PCT international publication number WO 95/25645, to Selberg Bengt, entitled “CHILD'S SAFETY SEAT”. He discloses “a child's safety seat for motor vehicles comprises two side pieces, a seat and a back section, and it is foldable, as said pieces are movable towards one another by folding of the seat and back sections It is also preferably lockable in unfolded condition by means of locking devices in the seat and back. Due to this design the folded safety seat requires little space and it can easily be stowed away when not in use.”

Bengt focuses on folding as the means for reducing the width of a child safety seat and does not look at other means for doing so. He does not fold the back to the seat, nor does he reduce the height of the back.

The present invention provides a solution in areas that are not addressed by the prior art. It provides a child safety seat that can be collapsed to a very compact size, substantially smaller then when fully opened. The seat's smaller size is particularly convenient for carrying it during travel, for example in a piece of luggage on a plane flight or stacked in a container for shipping from its place of manufacture. The greater reduction in volume that the present invention achieves compared to prior solutions means greater convenience and lower costs for the manufacturer, the distributor, and the end user.

The present invention provides a collapsible child safety seat comprising a backrest portion and a seating portion. From its volume when fully open (operating state) the parts of the safety seat can be collapsed to a much smaller volume as follows:
width of the backrest portion and the seating portion can be reduced, preferably by a contraction mechanism;
height of the backrest portion can be reduced, preferably by the backrest portion comprising a lower section for back support and an upper section for head support, where the head support section is retractable into the back support section;
depth of the seating portion can be reduced by pivoting the seating portion against the backrest portion by means of a hinged connection —the connection may be preferably implemented where the seating is pivotable up such that the top surface of the seating portion meets the front surface of the backrest portion, that the seating portion is pivotable down and around such that the bottom surface of the seating portion meets the back surface of the backrest portion, or that the seating portion is pivotable in both directions; and
the reduction and restoration mechanisms of the width and height are preferably integrated so that a single control mechanism implements change in both width and height or a change in one of these dimensions effects a related change in the other dimension.

It is therefore an object of the present invention to furnish a collapsible child safety seat that can be easily collapsed into a minimal and compact size.

It is a further object of the present invention to furnish a collapsible child safety seat that is lightweight.

It is a further object of the present invention to furnish a collapsible child safety seat that requires minimal storage space.

It is a further object of the present invention to furnish a collapsible child safety seat with a small volume, making it more convenient than existing child safety seats for transporting and shipping

### BRIEF DESCRIPTION OF THE INVENTION

There is thus provided in accordance with a preferred embodiment of the present invention, a collapsible child safety seat device for use in a vehicle, the device comprising a seating portion pivotally connected to a back support, the back support comprising a backrest portion and a headrest portion, wherein the seating portion and back support may be folded together, wherein the seating portion and the back support may be laterally narrowed, and wherein the headrest portion can be retracted or folded to at least partially overlap with the backrest portion, whereby the collapsible child safety seat device can be transformed between a deployed position where all the parts are deployed and a compact position where all the parts are collapsed.

Furthermore, in accordance with another preferred embodiment of the present invention, the seating portion has a top surface and a bottom surface, the back support has a front surface and a back surface, and wherein the seating portion may be folded such that the bottom surface of the seating portion is brought towards the back surface of the back support.

Furthermore, in accordance with another preferred embodiment of the present invention, the seating portion and the back support each comprise two or more parts that can be moved with respect to each other and between a deployed position and a narrowed position.

Furthermore, in accordance with another preferred embodiment of the present invention, the device is provided with a deployment mechanism that deploys or collapses one or more of the parts.

Furthermore, in accordance with another preferred embodiment of the present invention, the deployment mechanism translates motion in one direction to motion in another direction.

Furthermore, in accordance with another preferred embodiment of the present invention, the motion in one axis is forced directly by a user.

Furthermore, in accordance with another preferred embodiment of the present invention, the deployment mechanism slidably deploys or collapses one or more of the parts.

Furthermore, in accordance with another preferred embodiment of the present invention, the deployment mechanism can deploy or collapse some or all of the parts simultaneously.

Furthermore, in accordance with another preferred embodiment of the present invention, the collapsible child safety seat device is provided with a restrainer.

Furthermore, in accordance with another preferred embodiment of the present invention, the restrainer comprises one or more straps.

Furthermore, in accordance with another preferred embodiment of the present invention, the collapsible child safety seat device is provided with at least one of a plurality of rigid anchors or latches for anchoring the device to the vehicle.

Furthermore, in accordance with another preferred embodiment of the present invention, each of the portions of the device comprises at least one continuous rigid member.

### BRIEF DESCRIPTION OF THE FIGURES

The invention is described herein, by way of example only, with reference to the accompanying Figures, in which like components are designated by like reference numerals.

FIG. 1 illustrates a booster embodiment of a child safety seat according to a preferred embodiment of the present invention, the booster provided with a rigid anchor.

FIG. 2A is a side view of the primary components of a child safety seat in a deployed state in accordance with a preferred embodiment of the present invention.

FIG. 2B is a side view of the primary components of a child safety seat in a compact state in accordance with a preferred embodiment of the present invention.

FIG. 3 is an isometric view of the primary structural components of a child safety seat in a deployed state in accordance with a preferred embodiment of the present invention.

FIG. 4A is a front view of the primary structural components for extending and for providing rigidity to a child safety seat in a deployed state in accordance with a preferred embodiment of the present invention.

FIG. 4B is a front view of the primary structural components for narrowing and for providing rigidity to a child safety seat in a compact state in accordance with a preferred embodiment of the present invention.

FIG. 5A is the view of FIG. 4A with the continuous rigid members removed.

FIG. 5B is the view of FIG. 4B with the continuous members removed.

FIG. 6A reveals a headrest component of an exemplary deployment mechanism.

FIG. 6B reveals a backrest component of an exemplary deployment mechanism.

FIG. 6C reveals the assembly of the headrest deployment component of FIG. 6A and the backrest deployment component of FIG. 6B to form an assembly that makes possible translated-motion deployment of lateral narrowing of portions of a child safety seat in accordance with a preferred embodiment of the present invention.

FIG. 7A reveals a lateral narrowing mechanism in accordance with an alternative preferred embodiment of the present invention.

FIG. 7B shows initial activation of the lateral narrowing embodiment shown in FIG. 7A.

FIG. 7C shows further compaction by folding along pivotal connections of the embodiment shown in FIG. 7A.

FIG. 7D shows the final compaction the embodiment shown in FIG. 7A.

FIG. 8A reveals a lateral narrowing mechanism accordance with an alternative preferred embodiment of the present invention.

FIG. 8B reveals the lateral narrowing embodiment shown in FIG. 7A when the child safety seat is deployed.

FIG. 9A reveals a mechanism for reducing height and width in accordance with an alternative preferred embodiment of the present invention.

FIG. 9B shows initial compaction of the embodiment shown in FIG. 8A.

FIG. 9C shows final compaction of the embodiment shown in FIG. 8A.

FIG. 10A illustrates a side view of an alternative embodiment of a child safety seat where the retraction of the headrest is accomplished by pivotal connection to the backrest.

FIG. 10B shows the child safety seat of FIG. 10A in a first stage of compaction.

FIG. 10C shows the child safety seat of FIG. 10A in a second stage of compaction.

FIG. 10D shows the child safety seat of FIG. 10A in a final stage of compaction.

### DETAILED DESCRIPTION OF THE INVENTION

The present invention provides a child safety seat or booster for use in a vehicle and that can be opened for use or collapsed for handling.

In the booster embodiment, the seat of the present invention is anchored to the vehicle's permanent seat by an anchoring component. Examples of this component include one or more straps, the vehicle's safety belt, or one or more rigid anchors or latches such as used in the ISOFIX system developed by Britax Excelsior Limited of England, United Kingdom and described in U.S. Pat. Nos. 5,524,965, 5,487,588, and 5,466,044. The ISOFIX system was made public domain by Britax Excelsior.

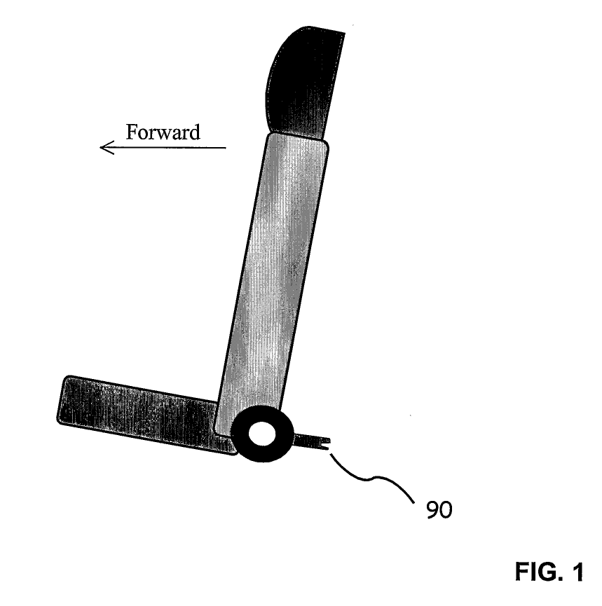

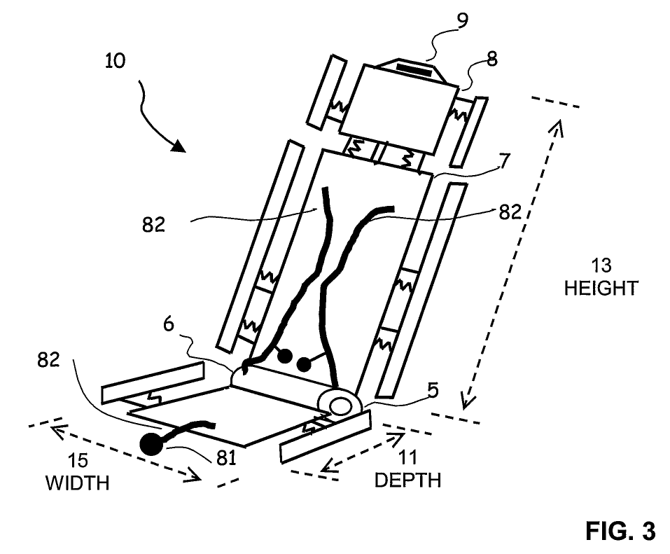

FIG. 1 illustrates a booster embodiment of a seat according to a preferred embodiment of the present invention, the booster provided with at least one of a plurality of rigid anchors 90. FIG. 3 illustrates child safety seat preferred embodiment of the present invention provided with an integrated restrainers in the form of one or more belts 82 that join together at clasp 81.

For the purposes of clarity in this disclosure, the term “child safety seat” when applied to the current invention should be taken to refer equally to a “booster” unless specified otherwise.

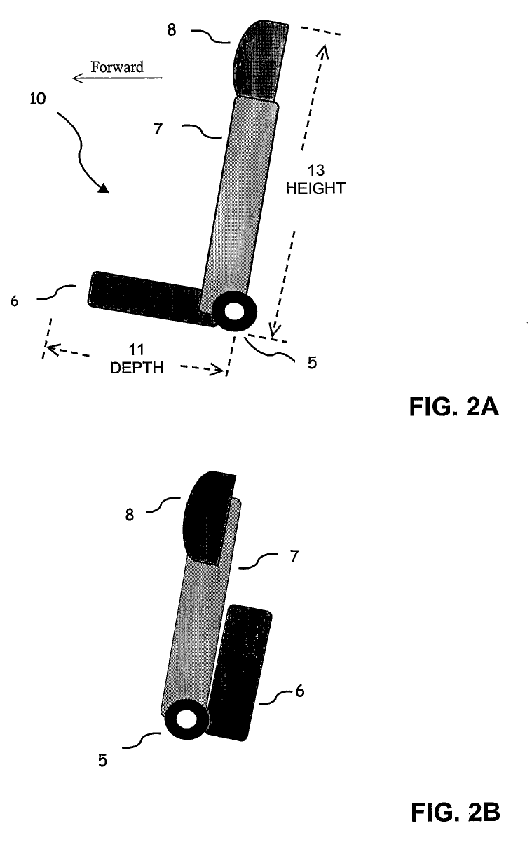

FIG. 2A is a side view and FIG. 3 is an isometric view of a child safety seat 10 in an opened state in accordance with a preferred embodiment of the present invention. The forward facing direction of the seat is indicated with an arrow.

Seat 10 comprises a seating portion 6 on which the child sits and a back support comprising a backrest portion 7 that supports the child's back and a headrest 8 portion that supports the child's head. Seating portion 6 is pivotally connected to backrest portion 7, whereby seating portion 6 and back support may be folded together as in FIG. 2B, thereby reducing the seat height (demarcated as 13 in FIG. 3). According to a preferred embodiment of the present invention, the direction of pivoting is such that the bottom surface of seating portion 6 is brought towards the back surface of back portion 7. According to an alternative embodiment of the present invention, the direction of pivoting can be such that the top surface of seating portion 6 is brought towards the front surface of back portion 7.

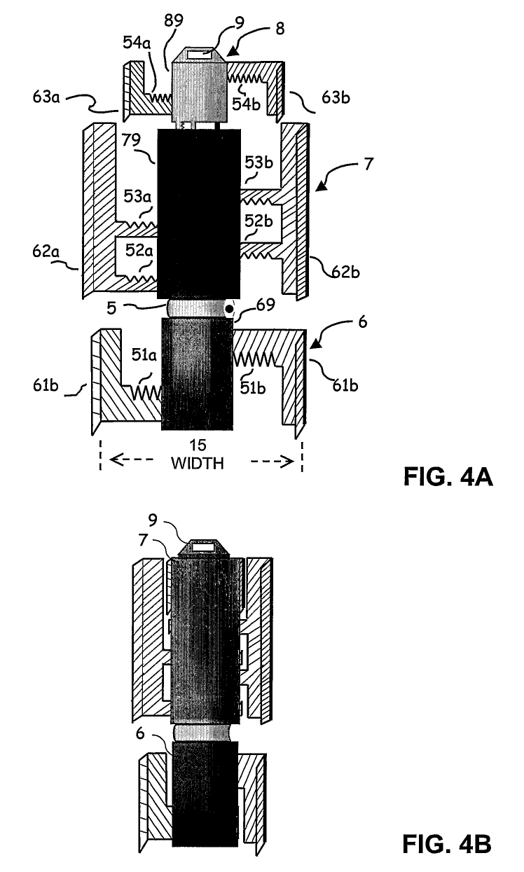

Furthermore, seating portion 6 and back support components backrest portion 7 and headrest portion 8 may be laterally narrowed as in FIG. 4B, thereby reducing the seat width (demarcated as 15 in FIG. 3). The lateral narrowing mechanism is described in more detail later in this disclosure.

Furthermore, headrest portion 8 may be retracted or folded to at least partially overlap with backrest portion 7 as in FIG. 2B, thereby reducing the seat height (demarcated as 13 in FIG. 3). In a retractable embodiment, the headrest portion 8 is slidably attached to backrest 7 such that headrest 8 can be pulled up for deployment or pushed down into backrest 7 for compacting.

These compacting features make it possible to change the size of the child safety seat, moving between a maximized deployed (open) position where the seat portions are deployed and a minimized compact (collapsed) position where the portions are collapsed.

In its deployed state, the child safety seat of the present invention is ready for use as a child safety seat in a vehicle. In its compact state, the child safety seat is reduced to a minimal size that is particularly convenient and portable for carrying around, efficient storage, efficient shipping, and other handling.

The present invention focuses on the structural elements of child safety seat 10, those elements that enable collapsing the seat when not in use to a minimal size. Other elements of a child safety seat, such as the seat fabric, cushion materials, type of restraint mechanism, means for securing the child safety seat to the vehicle seat, and so forth are not the focus of the present invention, and may or may not be incorporated in its materialization. Therefore most standard means for these elements can be used in the present invention. For example, the seat fabric could be a standard washable durable flame resistant cloth, the cushion could be flame-resistant foam rubber, and so forth.

This disclosure now discusses in greater detail a lateral narrowing mechanism that enables reduction of seat width 15 by narrowing seating portion 6, backrest portion 7, and headrest portion 8. In each portion, two or more parts can be moved with respect to each other and between a deployed position and a narrowed position

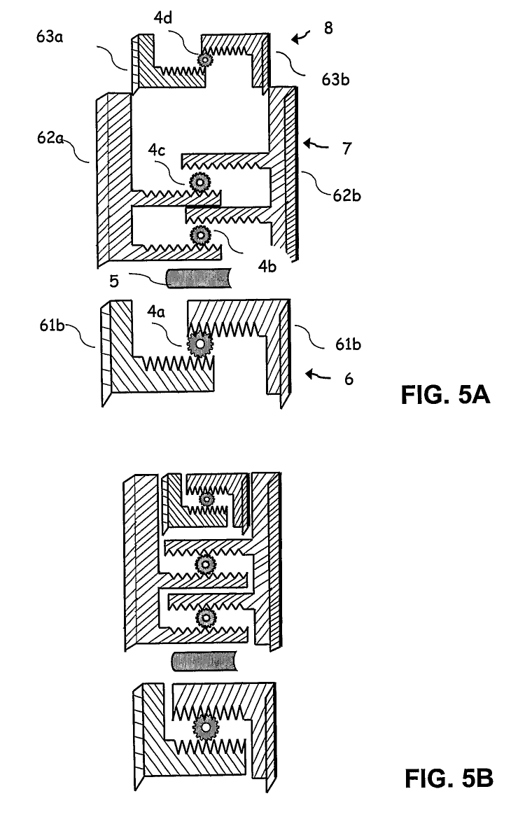

FIGS. 4A and 5A show these portions (with non-structural components removed) in deployed state and FIGS. 4B and 5B show these portions in compact state after lateral narrowing. It will be noted that in FIG. 4B, headrest portion 8 is mostly hidden because, in addition to being laterally narrowed it has been retracted into backrest portion 7.

In addition to narrowing parts, each portion of the seat comprises at least one continuous rigid member that provides reinforcement and rigidity to the portion. With reference to FIG. 4A, continuous rigid members are indicated as 69 for seating portion 6, 79 for backrest portion 7, and 89 for headrest portion 8. The rigid members are not shown in FIG. 5A and FIG. 5B, thereby revealing further parts of the narrowing mechanism.

In a preferred embodiment of the present invention the narrowing mechanism generally comprises elongated rigid elements that to extend the sides of a portion to a deployed position and slide back to withdraw the sides to a compact position. This mechanism can be implement in many ways by one skilled in the art. In FIGS. 4A, 4B, 5A, and 5B it is implemented by means of toothed rods actuated by gears.

More specifically the longitudinally moving parts involved in lateral narrowing are as follows:

For seating portion 6, seating gear 4a moves seating toothed members 51a and 51b, thereby respectively moving seating sides 61a and 61b.

For backrest portion 7, backrest gear 4b moves backrest toothed members 52a and 53a, thereby moving backrest side 62a; while backrest gear 4c moves backrest toothed members 52b and 53b, thereby moving backrest side 62b.

For headrest portion 8, headrest gear 4d moves headrest toothed members 54a and 54b, thereby respectively moving headrest sides 63a and 63b.

Actuation of the compacting mechanisms (which include folding to reduce depth, narrowing to reduce width, and retracting or folding to reduce height) can all or in part be accomplished either by directing operating a portion's mechanism or by one or more deployment mechanisms.

To illustrate, direct operation of the backrest portion's 7 narrowing mechanism would be to push the sides of the backrest in to narrow it and to pull them out to deploy it. Alternatively, a deployment mechanism can be engaged to translate one motion into one or more other motions. For example, a mechanism that translates retraction of headrest portion 8 into simultaneous narrowing of both backrest portion 7 and headrest portion 8, thereby achieving both retraction and narrowing and doing so in a manner that is convenient for the user of the seat, who need only retract headrest portion 8.

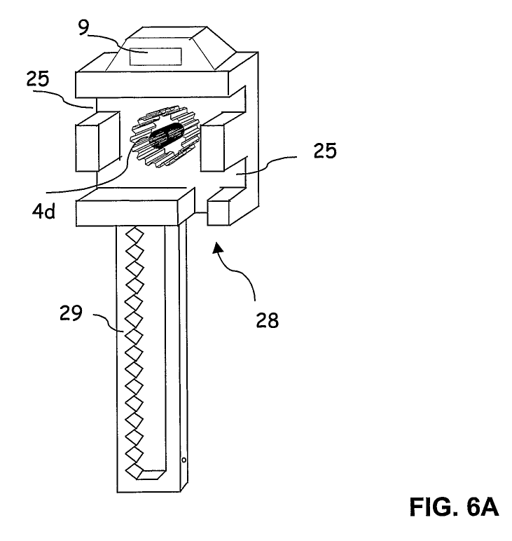

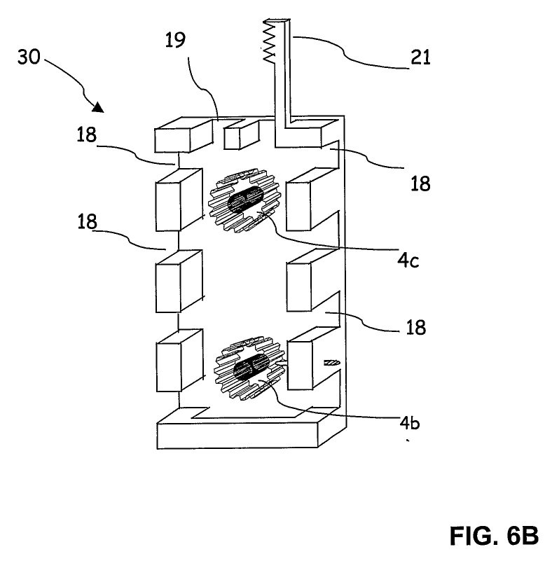

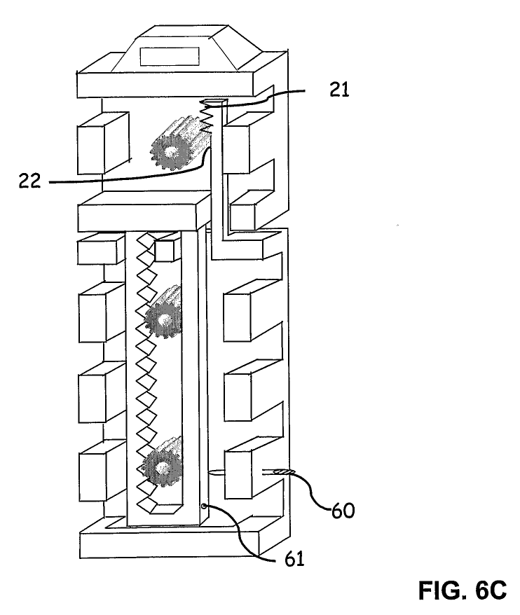

Such a mechanism is illustrated in FIG. 6A, FIG. 6B, and FIG. 6C. FIG. 6A reveals a headrest component 28 of an exemplary deployment mechanism, headrest deployment component 28 comprising handle 9 for the user to grip while retracting and extending headrest portion 8 (handle 9 is also shown in FIG. 4A and FIG. 4B), toothed elongated member 29, and slots 25 for passage of headrest toothed members 54a and 54b.

FIG. 6B reveals a backrest deployment component 30 of an exemplary deployment mechanism, backrest deployment component 30 comprising slot 19 for passage of headrest elongated element 29, slots 18 for passage of backrest toothed members 52a, 53a, 52b, and 53b, and toothed elongated member 21.

FIG. 6C reveals the assembly of headrest deployment component 28 and backrest deployment component 30, which makes possible translated-motion deployment of narrowing of backrest 7 and headrest 8, as follows: When a user moves (retracts or extends) headrest 8 by raising or lowering handle 9, toothed elongated member 29 translates the linear motion into rotation of backrest gears 4b and 4c, which motion is translated into linear motion (along an axis perpendicular to the original motion of the headrest) of backrest toothed members 52a, 53a, 52b, and 53b, thereby moving backrest sides 62a and 62b, and thereby narrowing or widening backrest 7.

At the same time, motion of headrest 8 also causes headrest gear 4d to move along toothed elongated member 21, thereby causing rotational motion of headrest gear 4d, which motion is translated into perpendicular linear motion of headrest toothed members 54a and 54b, thereby moving headrest sides 63a and 63b, and thereby narrowing or widening headrest 8.

It will be apparent to one skilled in the art that many such deployment mechanisms are possible. For example, the deployment mechanism shown in FIG. 6C can be extended to deploy seating portion 6 as well by extending toothed elongated member 29 to reach seating gear 4a, thereby applying the actuating user motion to seating toothed members 51a and 51b as well, and thereby moving seating sides 61a and 61b.

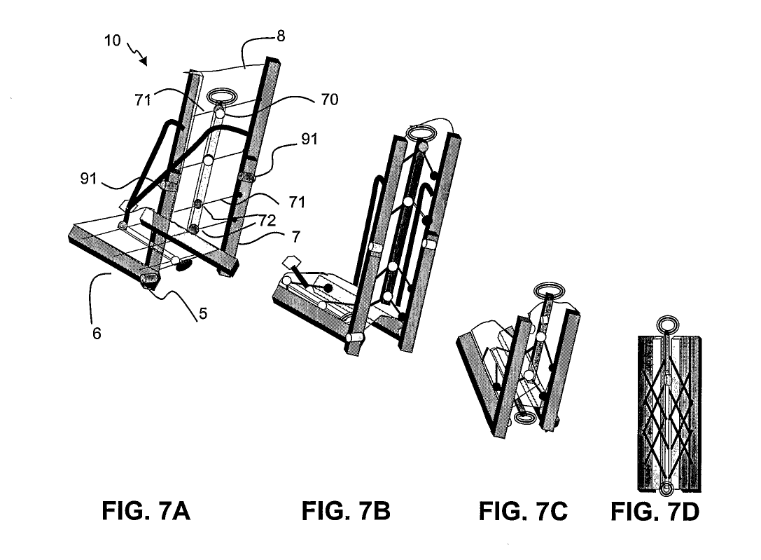

It will also be apparent to one skilled in the art that various alternative laterally narrowing mechanisms are possible. For example, FIG. 7A illustrates a structure of rigid elongated elements 71 pivotally connected 72 such that vertical movement of elongated element along the lateral plane of backrest portion 7 and headrest portion 8 narrows and widens those portions as well as seating portion 6. A similar mechanism is employed to laterally narrow seating part 6.

FIG. 7B shows initial activation of this lateral narrowing mechanism. FIG. 7C shows further compaction by folding along pivotal connections 91 and 5. FIG. 7D shows the final compacted child safety seat.

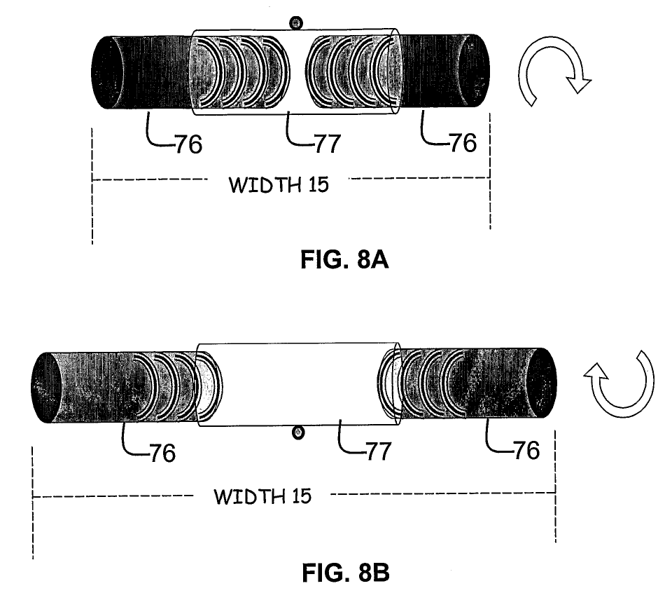

Another embodiment of a mechanism for lateral narrowing of a child safety seat is disclosed in FIG. 8A and FIG. 8B. In this embodiment, the portions of the seat are constructed of supports 76, which comprise tubes threadably joined to lateral narrowing actuator 77. Rotating lateral narrowing actuator 77 in one direction narrows the distance between lateral supports 76 (FIG. 8A) thereby reducing width 15 of the child safety seat. Rotating it in the other direction increases the distance between lateral supports 76 (FIG. 8B) thereby increasing the width 15 of the child safety seat.

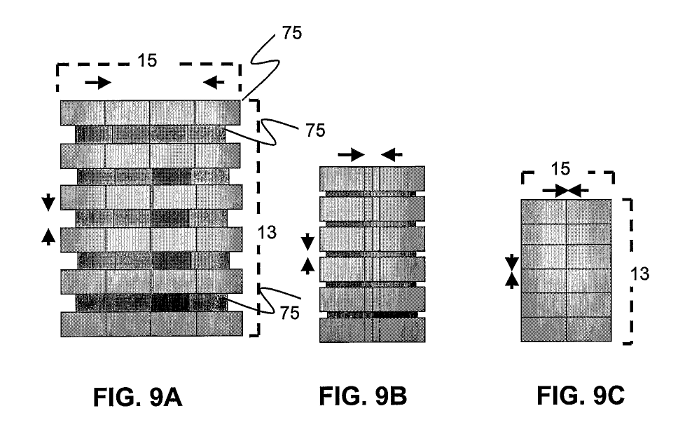

An alternative embodiment for both lateral narrowing of portions 6, 7, and or 8 and for retraction of any or all of those portions is shown in FIG. 9A, where various flaps 75 that are pivotally or slidingly connected enable deployment and compaction (FIG. 9B, FIG. 9C) along the width extension 15 and the height extension 13.

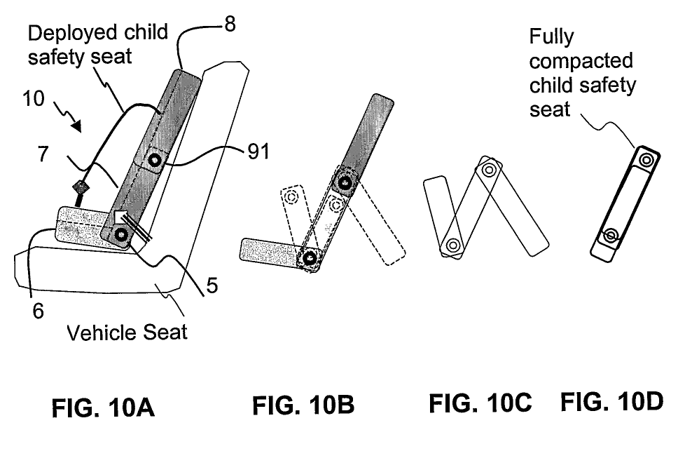

It will be apparent to one skilled in the art that various alternative headrest retractive mechanisms are also possible. For example, FIG. 10A illustrates an alternative preferred embodiment of the present invention in full deployment, with headrest portion 8 is pivotally connected to backrest portion 7 such that for retraction, headrest portion 8 is folded onto backrest portion 7.

FIG. 10B shows the pivotal connection 91 of headrest portion to backrest portion as well as the aforementioned pivotal connection 5 of seating portion to backrest portion 7. FIG. 10C shows the process of pivoting the portions. FIG. 10D shows the final, compacted child safety seat 10.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A collapsible child safety seat device for use in a vehicle, the device comprising a seating portion pivotally connected to a back support, the back support comprising a backrest portion and a headrest portion, wherein the seating portion and back support may be folded together, wherein the seating portion and the back support may be laterally narrowed, and wherein the headrest portion can be retracted or folded to at least partially overlap with the backrest portion,
whereby the collapsible child safety seat device can be transformed between a deployed position where all the parts are deployed and a compact position where all the parts are collapsed.

2. The device of claim 1, wherein the seating portion has a top surface and a bottom surface, the back support has a front surface and a back surface, and wherein the seating portion may be folded such that the bottom surface of the seating portion is brought towards the back surface of the back support.

3. The device of claim 1, wherein the seating portion and the back support each comprise two or more parts that can be moved with respect to each other and between a deployed position and a narrowed position.

4. The device of claim 1, wherein the device is provided with a deployment mechanism that deploys or collapses one or more of the parts.

5. The device of claim 4, wherein the deployment mechanism translates motion in one direction to motion in another direction.

6. The device of claim 5, wherein the motion in one axis is forced directly by a user.

7. The device of claim 4, wherein the deployment mechanism slidably deploys or collapses one or more of the parts.

8. The device of claim 4, wherein the deployment mechanism can deploy or collapse some or all of the parts simultaneously.

9. The device of claim 1, further provided with a restrainer.

10. The device of claim 9, wherein the restrainer comprises one or more straps.

11. The device of claim 1, further provided with at least one of a plurality of rigid anchors or latches for anchoring the device to the vehicle.

12. The device of claim 1, wherein each of the portions comprises at least one continuous rigid member.
